(19) United States
(12) Patent Application Publication
(10) Pub. No.: US 2002/0025850 A1
(43) Pub. Date: Feb. 28, 2002

(54) Electronic gaming monitoring and reporting system

(76) Inventor: Jon K. Hafezi, Charlotte, NC (US)

Correspondence Address: DOUGHERTY & CLEMENTS, TWO FAIRVIEW CENTER, 6230 FAIRVIEW ROAD, SUITE 400, CHARLOTTE, NC, 28210, US

(21) Appl. No.: 09/861,785

(22) Filed: May 21, 2001

Related U.S. Application Data
(63) Continuation-in-part of application No. 09/493,541, filed on Jan. 28, 2000.

(51) Int. Cl. A63F 13/00

(52) U.S. Cl. 463/29

(57) ABSTRACT

An apparatus for monitoring and reporting electronic gaming that may be coupled to existing electronic gaming devices or terminals. The apparatus includes a microprocessor controlled electronic interface printed circuit board and associated operating software having many different types of interface ports to connect to peripheral devices of the gaming terminal such as a redemption device and a monetary depositing device. The apparatus includes ports that capture the increment count on mechanical meters as well as ports to connect to security switches in the original gaming terminals such as main door, cash door(s), and logic door. The apparatus also includes a power monitor for monitoring the power supplied to the electronic gaming terminal as well as means to disrupt the operation of the player's interface devices, such as a button control panel or touch screen. The invented apparatus also includes other ports for networking a group of terminals together and transmitting the activity of the terminals via an ethernet interface port to a central data base computer.

### CROSS-REFERENCE TO RELATED APPLICATION

This application is a continuation in part of U.S. patent application Ser. No. 09/493,541 filed on Jan. 28, 2000.

### FIELD OF THE INVENTION

The present invention relates to a system for accounting, reporting and tracking monetary transactions and game plays of electronic gaming devices. The invention more particularly relates to an apparatus that interfaces with redemption devices that are integrated within gaming terminals without interfacing with control mechanisms (logic or computer system) of such gaming terminals to provide accurate accounting and player tracking information.

### BACKGROUND OF THE INVENTION

Electronic gaming, including but not limited to Reel and Video Slots, Video Poker, and Video Black-Jack, are becoming an increasingly popular form of entertainment. As the popularity of gaming increases, management, auditors and regulatory bodies are facing tasks such as cash control by means of constant accounting and auditing the monetary transactions of these gaming terminals. Management and marketing personnel for the gaming establishments are also interested in the gaming establishment playing activity, habits and interests of patrons. In addition to such tasks, management has to combat theft and fraudulent claims.

The gaming terminals allow players to redeem their winnings in some sort of cash or cash equivalent. The terminals are usually equipped with a redemption device such as coin or bill hopper, voucher or coupon printer, magnetic or smart card reader/writer. These redemption devices are generally integrated within the gaming terminal and are controlled by the logic device (e.g., computer system) of the terminal. Players are able to receive their winnings or a claim for their winnings from the gaming terminals via these redemption devices by activating a switch, depressing a button, or touching an area on the video screen to cause the hopper to redeem coins or bills. Alternatively, a printer mechanism provides a printout of a claim voucher or bar coded coupon, or an electronic device, such as a smart card, records the winnings on an electronic media.

Redemption systems and, in general, the entire gaming operation in any gaming establishment require a great deal of accountability and security as the gaming industry, due to the nature of being a cash business, has always been under the scrutiny of government, the gaming regulators and auditing authorities, such as the Internal Revenue Service.

Each system of redemption and in general, each particular gaming terminal has peculiarities in design that are unique to the gaming terminal and, therefore, ways of committing fraud. For example, a dishonest employee in the establishment may skim coins or bills from the hopper every time that the employee services a gaming terminal. In the case that the gaming terminal uses a printer mechanism, the establishment can be the target of counterfeiters who might be able to duplicate claim vouchers. If the method of redemption is via electronic media writers, such as magnetic or smart card writers, the gaming terminal may be subject to computer hackers. In short, any establishment without an adequate system of accounting and method to validate winning claims face a very short business life.

Currently, some companies such as International Game Technology (IGT), Bally Gaming Corporation and others have developed systems to connect to the gaming terminals and to a central monitoring computer. These systems produce accounting, player tracking and other pertinent information for the management, auditors, regulators and any other concerned party associated with the gaming establishments. These systems also vary in operation and range in the type and accuracy of information that the systems provide. Some advanced systems communicate directly to the controller or logic device of the gaming terminal via some sort of communication channel such as a serial or modem connection. In this system, the gaming terminal, or more particularly the logic device, must communicate all pertinent information to the collecting central accounting and information system. This type of system generally utilizes a central computer system that collects information, categorizes, sorts and usually stores the information in a data base format on an electronic media, such as the computer hard drive. The communication between the gaming terminal and the central computer system is conducted in a preformatted method commonly known as a protocol. Protocols are normally established by the designers of the central computer and electronic storage system, or the data base, and require the manufacturer of the gaming terminals, to provide a matching protocol and a means for communication between the gaming terminal and the central computer system. Typically, manufacturers of the gaming terminals are different from the provider of the central computer system. This type of system that communicates to the gaming terminals via an established communication protocol provides the most level of security and accountability for the gaming establishments but requires a uniform and proprietary communication protocol between the gaming terminals and the central computer system. Protocol systems are generally very expensive and also require some advanced hardware and software capability on the part of the gaming terminal manufactures.

Other types of monetary information gathering systems and methods are available for gaming establishments to implement in their business. Even though some of these types of systems do not require any specific communication protocol between the gaming terminal and the central computer system. Such systems are generally inadequate in the type and the amount of information that are provided. Additionally, the systems are not very accurate and reliable about the monetary information gathered from the gaming terminal. This type of system normally relies on an external controller device that connects to the mechanical devices such as coin counters and hopper switches. The controller device is typically an electronic circuit board having input/output ports (I/O ports) that are connected in parallel to various mechanical devices and switches in the gaming terminal. The controller device captures and transmits the information to an associated data bank usually a central computer system. For example, at any time that the original gaming terminal's logic device produces a command, such as an electronic pulse, to increment a mechanical coin counter or to command an attached hopper device to dispense coins, tokens, or currencies. This controller captures such monetary information and transmits the information to an associated central computer system. Unfortunately, mechanical meters have an inherent inaccuracy or become inaccurate due to the age of the equipment and based on any change in impedance of the meters. Another problem is that such accounting systems for hopper based gaming terminals are slow at reporting monetary information. This type of system does not provide interfaces for gaming terminals that use printer mechanisms or a debit/credit device as a redemption vehicle and, consequently, have no actual means of validating or providing accurate information about the gaming terminals. Any variation in design of a host gaming terminal may result in the controller applying a load to the mechanical counter or to the logic device that causes a malfunction or miss count.

In general, these types of systems provide general information of the monetary transactions on a very specific type of gaming terminal that uses a coin hopper or a currency dispensing device. Normally, the gaming establishments are not concerned with stringent cash control, fraud and/or fraudulent claims. The hopper based gaming terminal provides the player with a tangible item that is representative of the player's winnings. For example, hopper-based electronic gaming terminals provide coins, tokens or currencies that are either minted or normally very expensive to duplicate.

Gaming establishments may sometimes be required to implement a secure and auditable means of cash control and verification under the relevant regulations. One of the relevant government gaming regulating bodies is the National Indian Gaming Commission (NIGC) who have regulating authority on Native American (Indian) gaming operations on Indian Reservations. Recently this commission has passed a resolution that requires all Native American gaming operations to implement an electronic system of validation, auditing, cash control, and management in gaming operations. One of the requirements is that any electronic gaming terminals having printer devices for winning redemption must provide a secure method of validating cash tickets (vouchers) through a central data bank. This means that each cash ticket must bear a unique number (validation number) on any printed ticket or voucher that cannot be easily regenerated or reproduced outside of the particular electronic gaming system. This unique number is used to authenticate the ticket upon ticket redemption in the electronic gaming system. This regulation also requires the gaming operations to electronically collect all pertinent accounting information from the gaming terminals such as the amount cash or cash equivalent (currency, coins, tokens, vouchers, bar coded coupons, debit or credit cards, etc.) that is deposited via a peripheral device such as currency, coin or token acceptor, magnetic or smart card reader, bar code reader, and alphanumerical key or touch pad input device in the gaming terminal for play by the patrons. It is also necessary to collect other accounting and gaming related information such as amount or account of games played or awarded by the gaming terminal and check against the theoretical pay percentage that is published by the gaming terminal manufacturer.

To comply with the relevant regulations or control standards, the existing electronic gaming terminals must either be retrofitted with new software and hardware to comply with the standards or must be exchanged with the new terminals that can meet the standards. In the case of retrofitting, the gaming operation have to rely on the original manufacturers of gaming terminals to develop retrofit software and hardware, and that means that they must extensively modify the exiting gaming terminals to comply with preset instructions and implement communication protocols that are dictated by the particular accounting and management system of the electronic gaming system. This is if the original manufacturer is still in business and is capable and willing to perform such task. Otherwise the gaming operation would face a much costlier rout and be forced to purchase new equipment.

What is therefore needed is an apparatus for monitoring and reporting electronic gaming that interfaces with existing and conventional electronic gaming terminals or devices. More particularly, what is needed is an apparatus for monitoring and reporting electronic gaming that provides accurate accounting and efficient management and control of electronic gaming terminals.

### SUMMARY OF THE INVENTION

The invention is an apparatus for monitoring and reporting electronic gaming that may be coupled to existing electronic gaming devices or terminals. In a preferred embodiment, the invention is an apparatus for monitoring and reporting monetary and transaction data from an electronic gaming terminal. The electronic gaming terminal has a logic board for implementing predetermined games on the electronic terminal, determining available credit entered into the gaming terminal by a player, determining winnings by the player, activating mechanical meters that are coupled to the gaming terminal to reflect the monetary transactions of the gaming terminal, and controlling a redemption device that is coupled to the gaming terminal.

The invented apparatus comprises a microprocessor controlled electronic interface printed circuit board (PCB) and associated operating software having many different types of interface ports to connect to peripheral devices of the target or the gaming terminal such as a redemption device and a monetary depositing device (such as those mentioned earlier) for monitoring and reporting such transactions. There are also ports that capture the increment count on the mechanical meters, as well as ports to connect to security switches in the original gaming terminals such as main door, cash door(s), and logic door. There is also a means for monitoring the power in the original equipment as well as means to disrupt the operation of the player's interface devices such as button control panel or touch screen. The invented apparatus also comprises other ports for networking a group of terminals together and transmit their activity via a Ethernet interface port to the central data base computer. This method reduces the number of communication connections (wiring) that would be required to connect each gaming terminal to the central computer and accounting system. The invented apparatus may further comprise a player tracking port for connecting to a player card reader that downloads and updates player transaction history at the gaming terminal. The invented apparatus may additionally comprise a progressive port or jackpot port for transmitting jackpot information to an external server. All ports provided by the invented apparatus may be parallel or serial or discrete in configuration.

The programmable microprocessor based logic device (PLD) is preferably programmed to control the communication and functions for each port. For example, the PLD monitors and gathers and then transmits to the central data base computer winnings information that the redemption device such as coin hopper dispensed to the patron as winnings. In one embodiment, the PLD also interrupts the connection from the original gaming terminal's logic device to the printer device in order to attach a unique verification number to the ticket or voucher dispensed by the printer device and transmit this information to the central computer system. Thus, the system management can authenticate the validity of the dispensed cash voucher or ticket and provides accurate accounting of winnings from the particular gaming terminal.

In another embodiment, the PLD has an optional port that can be connected to a unique printer for printing special bar coded cash voucher coupons or cash tickets that bear the same unique validation number. These vouchers can be redeemed at the Cashier's terminal that validates the vouchers through the system. Alternatively, the patrons may chose to continue their wagers on other gaming terminals throughout the gaming establishment by simply inserting such cash vouchers into a credit input device of another gaming terminal and receive equivalent credit for wagering. The credit input device of the gaming terminal receives the bar coded cash voucher and through this system authenticates the voucher before rendering any credit to the player.

When currency acceptors are used in the electronic gaming terminal, the interface board is electronically connected to the currency acceptor to monitor the amount of credit received by the gaming terminal. This allows for accurate accounting of cash paid into the gaming terminal and awarded by the gaming terminal. The invented apparatus also connects to the mechanical meters, in particular to the “PLAYED” and the “AWARD” or “WON” meters, which is particularly useful for complying with guidelines that require a check on the theoretical percentage of pay-out from gaming terminals.

A player tracking device, such as a card reader, may be used with the gaming terminal. In such case, the interface board includes a port for electronically connecting to the player tracking device. The PLD is able to download and update player activity related to the particular gaming terminal. This is particularly useful when implementing a player reward system that is based on player activity in the gaming system.

The invented apparatus is preferably powered independently of the electronic gaming terminal. In the event of power failure, such a disruption of power supplied to the gaming terminal, the interface board detects such power failure and reports the same to the central monitoring system or to gaming authorities.

In one embodiment, the interface board may further include electronic relays that can be positioned between player interface devices, such as buttons or a touch-screen, and the logic board that disable the gaming terminal during malfunction of the gaming terminal or when the maintenance door is ajar.

In one embodiment, the interface board may further connect to the security switches that may detect any door opening or closures in the gaming terminal and report such event to the central monitoring system or the gaming authorities.

### OBJECTS OF THE INVENTION

The principal object of the present invention is to provide an apparatus for monitoring and reporting and validating the monitory transactions, on existing electronic gaming terminals.

Another more particular object of the invention is to provide an apparatus for monitoring and reporting electronic gaming that may be coupled to a printer-based existing electronic gaming terminal or a hopper based electronic gaming terminal.

Another object of the invention is to provide an apparatus for monitoring and reporting electronic gaming that is accurate in accounting and efficient at managing the cash control of the electronic gaming terminal.

Another object of the invention is to provide an apparatus for monitoring and reporting electronic gaming that complies with National Indian Gaming Commission regulations.

### BRIEF DESCRIPTION OF THE DRAWINGS

The foregoing and other objects will become more readily apparent by referring to the following detailed description and the appended drawings in which:

FIG. 1 is an isometric view of a known electronic gaming terminal, according to prior art.

FIG. 2 is a schematic diagram of the electronic gaming terminal shown in FIG. 1, according to prior art.

FIG. 3 is a schematic diagram of an electronic gaming terminal coupled with an apparatus for monitoring and reporting monetary and transaction data in accordance with the present invention.

### DETAILED DESCRIPTION

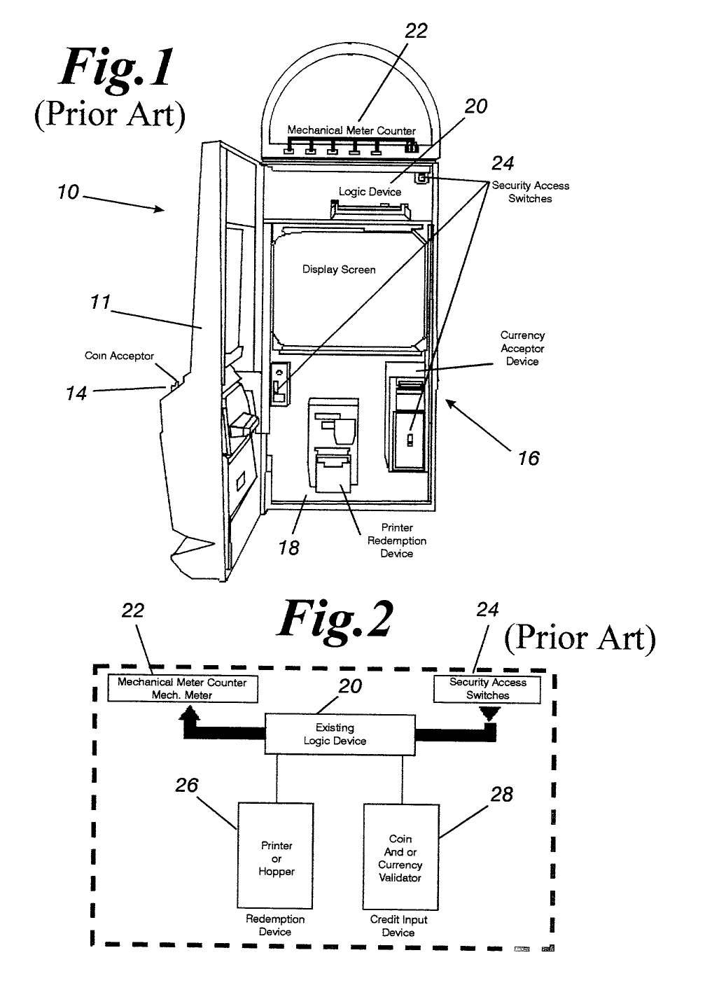

Referring now to the drawings, FIG. 1 is an isometric view of a known electronic gaming terminal, shown generally at 10. The electronic gaming terminal 10 has a housing with an access 11 to the electronic components contained within the gaming terminal 10. The electronic components include a display screen 12 for presenting an electronic game to a player, a logic device, shown generally at 20, for operating the electronic game, a coin acceptor, shown generally at 14, that is electronically connected to the logic device 20, a currency acceptor, shown generally at 16, that is electronically connected to the logic device 20, a printer redemption device, shown generally at 18, that are electronically connected to the logic device 20, mechanical counters, shown generally at 22, the are electronically connected to the logic device, and security access switches 24 that are electronically connected to the logic device.

The display screen 12 may be interactive, such as a conventional touch screen. Alternatively, the gaming terminal 10 may include a button control panel to allow the player to make game selections. Credits, such as coins or currency, for playing games are inputted by the player in the coin acceptor 14 and/or currency acceptor 16. The printer redemption device 18 provides a claim voucher of any winnings won by the player at the gaming terminal. The mechanical counters 22 record the monetary transactions, such as credits and awards. To notify management and security of tampered electronic gaming devices, security access switches 24 are coupled to sensitive components of the gaming terminal 10, such as the access or main door 11 to the gaming terminal 10, the access to the currency acceptor or cash door 16, and the access to the logic device or logic door.

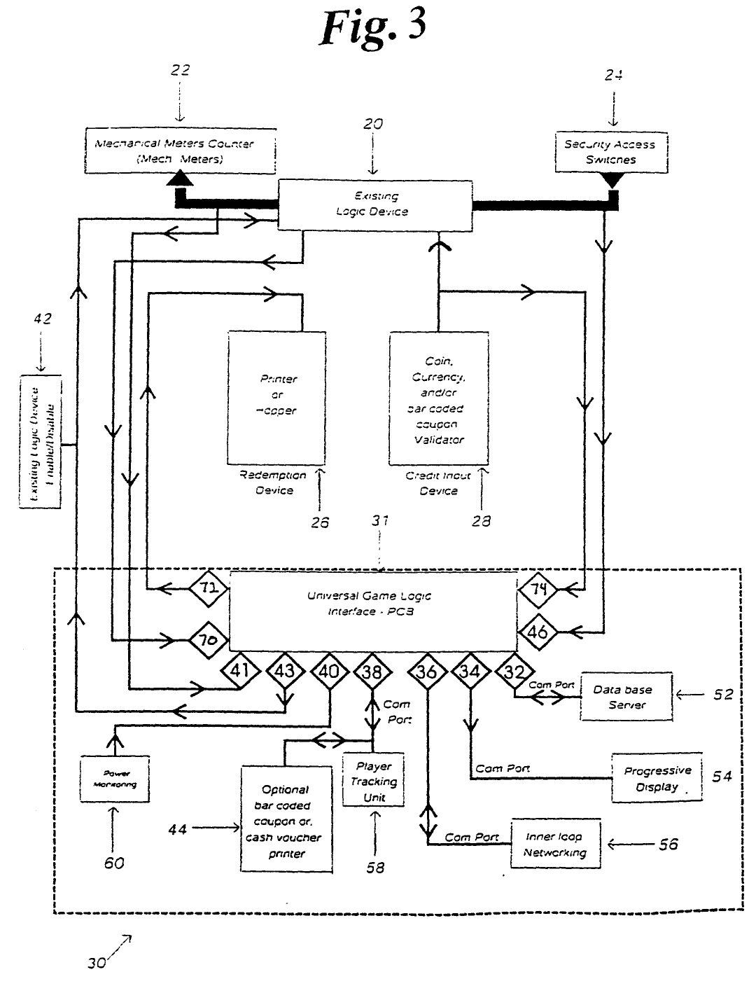

FIG. 2 is a schematic diagram of the electronic gaming terminal 10 shown in FIG. 1. The security access switches 24 are commonly electronically connected to the logic device 20 such that when the switches 24 are tripped, the switches transmit a signal to the logic device 20 indicating tampering of the gaming terminal 10. The logic device 20 receives information from a credit input device 28, such as the coin acceptor 14 (FIG. 1) and currency acceptor 28 (FIG. 1) regarding the amount of coin or currency inputted by the player at the gaming terminal 10. The logic device 20 instructs a redemption device 26, such as the printer redemption device 18 (FIG. 1) or a coin hopper, to distribute awards or winnings to the player in the form of claim vouchers or coins, respectively. Based on the amount played by the player and/or on the amount awarded or won by the player, the logic device 20 transmits a signal to the mechanical counters 22 to update the status of each counter. For example, one counter may reflect the amount won at a particular gaming terminal.

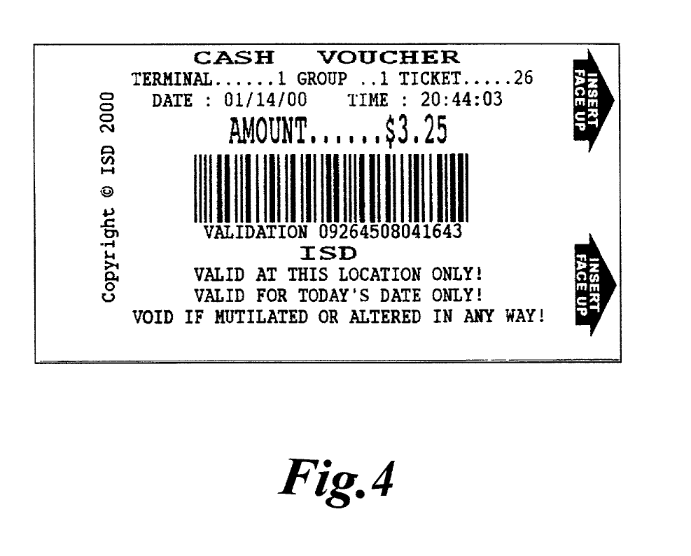

FIG. 3 is a schematic diagram of the components of an electronic gaming terminal coupled with an apparatus for monitoring and reporting monetary and transaction data, shown generally at 30, in accordance with the present invention. In a preferred embodiment of the present invention, the invented apparatus 30 for monitoring and reporting monetary and transaction data comprises a microprocessor controlled electronic interface printed circuit board (PCB) 31 and associated operating software, not shown. The operating software is specific to the machine being adapted and is preferably implemented in a predominately read-only memory that is non-volatile, that is, retains data without power. The PCB 31 has a plurality of interface ports to connect the PCB 31 to peripheral devices of the gaming terminal, such as the aforementioned redemption device 26 and credit input device 28, for monitoring and reporting electronic transactions between the peripheral devices and the logic device 20. In a preferred embodiment, the commands from the existing logic device 20 to the existing redemption device 26 are intercepted. Said commands are intercepted by PCB 31 at receiving port 70. These commands are then processed by the invented apparatus and appropriate data based on these commands forwarded via communication port 32 to the central data base server. The invented apparatus 30 then creates the appropriate signals to drive the existing redemption device 26 via the transmitting port 72. In the case where the redemption device is a voucher printer, a portable voucher can be issued by requesting a voucher number from the central computer. When adapting to some existing gaming machines, the connection between the existing credit input device and the receiving port 74 exists as shown, but rather that simply monitoring the player transaction as shown in FIG. 3, the data may be processed and the credit amount in the existing logic device updated via transmitting port 43. The PCB 31 includes ports 41 that capture the increment count on the mechanical meters 22, as well as security switch ports 46 to connect to the aforementioned security switches 24.

The PCB 31 includes a power monitor port 60 for monitoring the power supplied to the electronic gaming terminal 10. In this embodiment, the invented apparatus 30 constantly monitors and reports to the system operator any power interruption to the gaming terminal 10.

The PCB 31 includes electronic relay switch(es) 42 for disabling the operation of the player interface devices, button control panel or touch screen, in response to any tampering of the gaming terminal or power disruption to the gaming terminal. The invented apparatus 30 also includes additional ports 36 for networking a group of like terminals 56 together and an ethernet interface port 32 for transmitting the activity of the terminals to a central data base server 52 or central accounting server. Using the aforementioned networking ports 32, 36 reduces the number of communication connections that are required to connect each gaming terminal to a central computer and accounting system. The invented apparatus 30 may further comprise a player tracking port 38 for connecting to a player card reader or player tracking unit 58 that downloads and updates player transaction history at the gaming terminal. The invented apparatus 30 may additionally comprise a progressive port or jackpot port 34 for transmitting jackpot information to an external progressive controller or display 54. All ports provided by the invented apparatus30 may be parallel or serial or discrete in configuration.

The PCB 31 includes a programmable microprocessor based logic device (PLD) that preferably controls the communication and functions for each of the ports. For example, the PLD monitors and gathers and then transmits to the central data base server 52 winnings information that the redemption device 26, such as a printer device or a coin hopper, dispensed to the player as winnings. In one embodiment, the PLD also interrupts the connection from the gaming terminal's logic device 20 to the printing redemption device 18 (FIG. 1) in order to attach a unique verification number to the ticket or claim voucher dispensed by the printing redemption device 18 and transmit this information to the central data base server 52. Thus, system management can authenticate the validity of the dispensed claim voucher or ticket and provides accurate accounting of winnings from the particular gaming terminal.

When a currency acceptor 16 (FIG. 1) is used in the electronic gaming terminal 10, the PCB 31 is electronically connected to the currency acceptor 16 to monitor the amount of credit received by the gaming terminal 10. This allows for accurate accounting of cash paid into the gaming terminal. In one embodiment, the credit input device 28 (FIG. 3) may also be a bar coded voucher acceptor or validator. In this embodiment, the PCB 31 is electronically connected to the credit input device that is capable of reading the bar coded vouchers to monitor the amount of credit received by the gaming terminal 10. As previously mentioned, the invented apparatus 30 is capable of communicating the unique validation number of the accepted voucher and authenticating the validation number through an associated network system.

In one embodiment, the invented apparatus 30 also connects to the mechanical meters 22, in particular to a “PLAYED” and an “AWARD” or “WON” meter. This is particularly useful for complying with guidelines that require a check on the theoretical percentage of pay-out from gaming terminals.

As previously mentioned, a player tracking device 58 such as a card reader, may be used with the gaming terminal 10. In such case, the PCB 31 includes a port 38 for electronically connecting to the player tracking device. The PLD is able to download and update player activity related to the particular gaming terminal. This is particularly useful when implementing a player reward system that is based on player activity in the gaming system.

The invented apparatus 30 is preferably powered independently of the electronic gaming terminal 10. In the event of power failure, such as a disruption of power supplied to the gaming terminal, the PCB 31 detects such power failure and reports the same to a central monitoring system or to gaming authorities, as previously mentioned. In one embodiment, the PCB 31 may further include electronic relays that can be positioned between player interface devices, such as buttons or a touch-screen, and the PCB 31 to disable the gaming terminal during malfunction of the gaming terminal or when the access door 11 is ajar. In another embodiment, the PCB 31 is connected to the security switches 24 to detect any door opening or closures in the gaming terminal and report such event to the central monitoring system or the gaming authorities.

### SUMMARY OF THE ACHIEVEMENT OF THE OBJECTS OF THE INVENTION

From the foregoing, it is readily apparent that this invention is an apparatus that co-exists separately from an original electronic gaming device or terminal for the proposes of monitoring and reporting monetary transactions and accounting information to a central accounting system. The present invention provides a secure method of auditing and verifying prizes and/or winnings produced by the gaming device. The present invention provides a system of networking among original gaming terminals for the proposes of calculating and distributing at least one jackpot prize pool, collecting, categorizing, storing and reporting player information (player tracking) and for marketing and management. The present invention enables the gaming operation to implement a method of cashless operation and a method of converting a printer gaming terminal to a hopper type device and vise-a-versa. The present invention allows existing gaming terminals to be in compliance with conventional gaming regulations without an expensive retrofitting or replacement of existing gaming terminals. The present invention provides an apparatus for monitoring and reporting electronic gaming that may be coupled to a printer based electronic gaming terminal or a hopper based electronic gaming terminal. The present invention provides an apparatus for monitoring and reporting electronic gaming that is accurate in accounting and efficient at managing and controlling the electronic gaming terminal. The present invention provides an apparatus for monitoring and reporting electronic gaming that complies with National Indian Gaming Commission regulations.

It is to be understood that the foregoing description and specific embodiments are merely illustrative of the best mode of the invention and the principles thereof, and that various modifications and additions may be made to the apparatus by those skilled in the art, without departing from the spirit and scope of this invention, which is therefore understood to be limited only by the scope of the appended claims.

What is claimed is:

1. A method for monitoring and reporting monetary and transaction data from an existing electronic gaming terminal having a logic board, said method comprising:
programming a microprocessor for controlling communication between the existing electronic gaming terminal and a central accounting server;
receiving redemption data from the existing logic board; and,
receiving credit input data from the existing logic board; and,
transmitting a signal responsive to said redemption data and said credit data for enabling the existing electronic gaming terminal to operate.

2. A method in accordance with claim 1 further comprising progressively transmitting game information to the microprocessor, and displaying progressive game information; thereby enabling said existing electronic gaming device for progressive gaming.

3. A method in accordance with claim 1, further comprising connecting a plurality of electronic gaming terminals to a central accounting controller server.

4. A method in accordance with claim 1 further comprising tracking play electronically by said programmable microprocessor, and reporting the tracking results to a player card reader/writer.

5. A method according to claim 1, further comprising:
connecting a cash-in meter to the existing electronic gaming terminal;
determining a cash-out amount;
displaying said cash-out amount and crediting said cash-out amount on a cash won meter of the existing electronic gaming terminal.

6. A method for adapting an existing gaming machine of various designs having an existing logic device communicating with a centrally monitored and controlled environment, comprising:
a. providing a logic device capable of executing programs for said designs operatively connected to a microprocessor,
b. providing random access memory operatively connected to the microprocessor;
c. storing a program specific to the existing logic device,
d. receiving redemption signals from the existing logic device operatively connected to the microprocessor;
e. transmitting port for transmitting signals from the microprocessor to a redemption device;
f. receiving credit input signals from a credit input device operatively connected to the microprocessor; and
g. monitoring and controlling said existing logic device with a central computer.

7. A method according to claim 6 further comprising transmitting a signal to the existing gaming machine to enable or disable the operation thereof.

8. A method according to claim 6 further comprising transmitting redemption signals to an existing redemption device from the existing logic device, intercepting redemption signals from the existing logic device and operating the existing redemption device on command either directly or under control of the central computer.

9. A method according to claim 6, wherein said gaming machine includes a second redemption device of a substantially differing design than the existing redemption device, the method further comprising:
receiving existing redemption signals;
translating the existing redemption signals to redemption signals required by said second redemption device of substantially differing design; and
transmitting translated signals as required by said second redemption device of substantially differing design;
thereby replacing the existing redemption device by said second redemption device appropriate to said centrally monitored and controlling environment without interference with said existing logic device or the games available thereon.

10. A method according to claim 6, wherein said gaming machine has an associated existing credit device, said method further comprising:
receiving credit signals from a second credit device that differs substantially from said existing credit device;
translating said credit signals from said second credit device that differs substantially from said existing credit device to signals that emulate said existing credit device; and
transmitting said signals that emulate the existing credit device of substantially differing design to the existing logic device;
thereby replacing the existing credit device by said second credit device which is appropriate to said centrally monitored and controlling environment without interference with said existing logic device or the games available thereon.

11. A method according to claim 6, further comprising:
receiving a report of power status of the existing logic device;
providing an independent power source for operating the existing gaming machine; and
monitoring the operating status of the existing gaming machine by the central computer independent of whether the existing logic device is powered on.

12. A method according to claim 6 further comprising receiving data from the connections between the existing logic device and an existing mechanical meter; and
mirroring the data displayed by the mechanical meter in the gaming machine and in the central computer.

13. A method according to claim 6 further comprising adapting additional features to said existing gaming machine selected from the group consisting of: voucher reader/printers and smart card reader/writers, and
thus replacing existing redemption and credit facilities by redemption and credit facilities more appropriate to said centrally monitored and controlled environment without interference with said existing logic device or the games available thereon.

14. A method according to claim 6 further comprising enabling communication between said existing machine and other machines, thereby enabling multiple player gaming.

15. A method according to claim 6 further comprising transmitting progressive gaming data to an electronic display for presenting said data to players.
